(19) United States
(12) Patent Application Publication
(10) Pub. No.: US 2003/0207080 A1
(43) Pub. Date: Nov. 6, 2003

(54) Make and take

(76) Inventor: Jean Womack, Forest Lake, MN (US)

Correspondence Address: Jean Ione Womack, 456 South Shore Drive, Forest Lake, MN, 55025, US

(21) Appl. No.: 10/138,921

(22) Filed: May 6, 2002

(51) Int. Cl. B32B 3/10

(52) U.S. Cl. 428/137

(57) ABSTRACT

This is a piece of Silicone coated paper, with holes across the front to aid in measuring, leveling, and aligning. The surface being of silicone so a person may place and release stickers till they have the exact layout that is eye appealing to them.

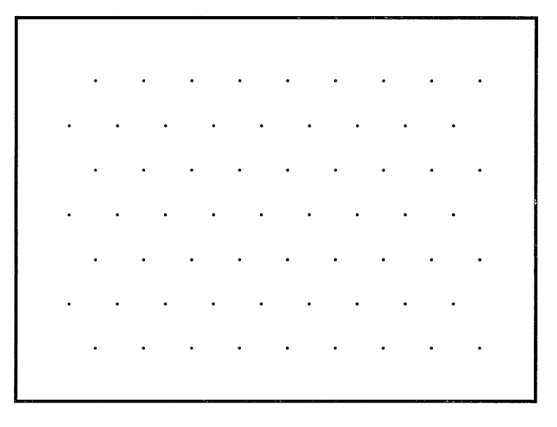

### BRIEF SUMMARY OF THE INVENTION

Broadly stated this invention is a measuring, leveling and layout template, that will help people who make Scrapbooks or memory books, it will help them with their pages and reduce errors and waste.

### BRIEF DESCRIPTION OF VIEWS OF DRAWINGS

This drawing is of the invention called MAKE AND MOVE, it is a flat silicone paper with holes punched strategically across it, it is white and rectangular in shape.

### DETAILED DESCRIPTION OF INVENTION

This invention is for the purpose of helping crafters with their scrapbook or memory book projects. It is a measuring, leveling and aligning tool. The silicone coating allows them the ability to reposition stickers until they achieve the look they want. The template is reusable.

The silicone face of this template paper allows you to position and reposition the stickers, as many times as you want until you achieve the look you want.

The holes, which cover the entire face of the template, allow you to align the pictures to get them straight and centered with out the help of a ruler.

When you have the stickers and pictures in place on the template just the way you want them, you place the template, over the top of your permanent page. Using a pencil you will make marks in the holes that match up with your design, remove the template and transfer the stickers and pictures on to the permanent page using your marks as guides.

The embodiment of the invention in which an exclusive property or privilege is claimed are defined as follows:

1. A sheet of paper with silicone coating on it, particularly useful for people in the Scrapbooking craft.
(a) White in color
(b) Rectangular in shape
(c) Holes strategically placed in a horizontal pattern, for measuring and leveling, and the transfer of these placements through the holes
(d) Silicone coated for the positioning and repositioning of craft stickers
